(19) United States
(12) Patent Application Publication
(10) Pub. No.: US 2024/0262332 A1
(43) Pub. Date: Aug. 8, 2024

(54) BRAKE DEVICE FOR HOST VEHICLE AND CONTROL METHOD THEREOF

(71) Applicant: HL MANDO CORPORATION, Gyeonggi-do (KR)

(72) Inventor: Seo Hyoung KIM, Gyeonggi-do (KR)

(21) Appl. No.: 18/412,473

(22) Filed: Jan. 13, 2024

(30) Foreign Application Priority Data
Feb. 6, 2023 (KR) 10-2023-0015449

(51) Int. Cl. B60T 13/74

(52) U.S. Cl. CPC B60T 13/741; B60T 2270/82

(57) ABSTRACT

The present disclosure provides an integrated brake device for a host vehicle, including a three-phase motor for generating a braking force to driving wheels of the host vehicle, first and second EPB motors for generating a parking braking force to rear wheels of the host vehicle, an H-bridge circuit including a plurality of switches and supplying a current to at least one of the three-phase motor and the first and second EPB motors, an EPB driver for controlling on/off of the plurality of switches to drive the first and second EPB motors, and a three-phase motor driver for controlling on/off of the plurality of switches to drive the three-phase motor.

### CROSS-REFERENCE TO RELATED APPLICATION

This application claims priority to and the benefit of Korean Patent Application No. 10-2023-0015449, filed on Feb. 6, 2023, the disclosure of which is incorporated herein by reference in its entirety.

### BACKGROUND

### 1. Field of the Invention

The present disclosure relates to a brake device for a host vehicle and a control method thereof, and more specifically to an integrated brake device which is capable of implementing the miniaturization of a product and cost reduction, and a control method thereof.

### 2. Discussion of Related Art

A brake system for braking is essentially installed in a host vehicle, and recently, various types of systems for obtaining more powerful and stable braking force have been proposed. As an example, the integrated dynamic brake (IDB) system has been proposed.

The IDB system includes a pressure generating device for outputting the operation of a brake pedal as an electrical signal through a pedal displacement sensor to operate a three-phase motor and converting the rotational force of the three-phase motor into linear motion to generate a braking hydraulic pressure, a valve block in which a plurality of valves are installed to control the braking operation by receiving a hydraulic pressure with the force generated by the pressure supply device, and an electronic control unit for controlling the three-phase motor and valves.

The electronic parking brake (EPB) system is a device that electronically controls the driving of the parking brake, and even if the driver does not manually operate the parking brake, when the host vehicle is stopped or when there is a risk of the host vehicle being pushed back when starting on a hill, it is automatically operated to maintain the parked or stopped state of the vehicle.

FIG. 1 is a schematic circuit diagram of a conventional integrated brake device for a host vehicle.

Referring to FIG. 1, the conventional integrated brake device for a host vehicle is configured by including a three-phase motor 10, EPB motors 21, 22, H-bridge circuits 31, 32, a three-phase inverter 33, an EPB driver 40, a three-phase motor driver 50 and a controller 60.

The three-phase motor 10 is a device that generates a braking force on the driving wheels of the host vehicle, and it generates a braking force on the driving wheels when a driver's will to brake is sensed from the brake pedal.

The EPB motors 21, 22 are devices that generate a parking braking force to the left and right rear wheels of the host vehicle during parking.

The H-bridge circuits 31, 32 are composed of two series circuits in which two switches are connected in series, respectively, and supply a current to the EPB motors 21, 22, respectively.

The three-phase inverter 33 is composed of three series circuits in which two switches are connected in series, respectively, and supplies a three-phase current to the three-phase motor 10.

The switches that are provided in the H-bridge circuits 31, 32 are turned on or off by the EPB driver 40, and the switches of the three-phase inverter 33 are turned on or off by the three-phase motor driver 50.

The controller 160 may apply a control signal to the EPB driver 140 and the three-phase motor driver 150 to drive the EPB driver 140 and the three-phase motor driver 150.

Such a conventional integrated brake device requires two H-bridge circuits 31, 32 for driving the EPB motors 21, 22 and a three-phase inverter 33 for driving the three-phase motor 10, and therefore, a total of 14 switches are required.

Therefore, it is necessary to develop an integrated brake device which is capable of miniaturizing a product and reducing component costs by reducing the number of components.

### SUMMARY OF THE INVENTION

An object of the present disclosure is to provide an integrated brake device which is capable of miniaturizing a product and reducing component costs by reducing the number of components.

In addition, another object of the present disclosure is to prevent host vehicle accidents by securing the redundancy of an integrated brake device.

The technical problems to be achieved in the present disclosure are not limited to the above-mentioned technical problems, and other technical problems that are not mentioned will be clearly understood by those skilled in the art from the description below.

In order to achieve the above-described objects, the present disclosure provides a brake device for a host vehicle, including a three-phase motor for generating a braking force to driving wheels of the host vehicle; first and second EPB motors for generating a parking braking force to rear wheels of the host vehicle; an H-bridge circuit comprising a plurality of switches and supplying a current to at least one of the three-phase motor and the first and second EPB motors; an EPB driver for controlling on/off of the plurality of switches to drive the first and second EPB motors; and a three-phase motor driver for controlling on/off of the plurality of switches to drive the three-phase motor.

Herein, the three-phase motor and the first and second FPB motors may be respectively supplied with a current by one H-bridge circuit.

In addition, the H-bridge circuit may include a first series circuit in which a first switch connected to a power supply and a second switch connected to a ground are connected in series through a first node; and a second series circuit in which a third switch connected to a power supply and a fourth switch connected to a ground are connected in series through a second node

In addition, the H-bridge circuit may include a third series circuit in which a fifth switch connected to a power supply and a sixth switch connected to a ground are connected in series through a third node; and a fourth series circuit in which a seventh switch connected to a power supply and an eighth switch connected to a ground are connected in series through a fourth node.

In addition, the EPB driver may control on/off of the first and second series circuits to drive the first EPB motor, and control on/off of the third and fourth series circuits to drive the second EPB motor.

In addition, the three-phase motor driver may control on/off of three series circuits among the first to fourth series circuits to drive the three-phase motor.

In addition, when any one of the first to fourth series circuits fails, the three-phase motor driver may control on/off of the remaining series circuits to drive the three-phase motor.

In addition, the first EPB motor may be connected to the first and second nodes, and the second EPB motor may be connected to the third and fourth nodes.

In addition, the three-phase motor may be connected to three nodes among the first to fourth nodes.

In addition, when the first and second EPB motors and the three-phase motor are simultaneously driven, the EPB driver may drive only one of the first and second EPB motors.

In addition, when the first and second EPB motors and the three-phase motor are simultaneously driven, the three-phase motor driver may control on/off of two series circuits among the first to fourth series circuits to drive the three-phase motor.

In addition, the integrated brake device for a host vehicle according to the present disclosure may further include a controller for applying control signals to the EPB driver and the three-phase motor driver.

In addition, the EPB driver may supply a current to the first and second EPB motors in the forward or reverse direction through the H-bridge circuit.

In addition, the three-phase motor driver may control the magnitude of a current that is supplied to the three-phase motor through the H-bridge circuit.

In addition, the three-phase motor driver may control the on-off duty ratio of the plurality of switch elements to adjust the magnitude of a current that is supplied to the three-phase motor.

In addition, the present disclosure provides a method for controlling a brake device for a host vehicle, which is a method for controlling a brake device for a host vehicle including first to fourth series circuits in which two switches are connected in series between a power supply and a ground, and an H-bridge circuit for supplying a current to at least one of a three-phase motor and first and second EPB motors, the method including the steps of driving the first EPB motor by controlling the first and second series circuits and driving the second EPB motor by controlling the third and fourth series circuits when a parking braking force is generated in rear wheels of the host vehicle; and driving the three-phase motor by controlling on/off of three series circuits among the first to fourth series circuits when a braking force is generated in driving wheels of the host vehicle.

Herein, the step of driving the three-phase motor may be a step of driving the three-phase motor by controlling on/off of the remaining series circuits when any one of the first to fourth series circuits fails.

In addition, the step of driving the first and second EPB motors may be a step of driving only one of the first and second EPB motors when the first and second EPB motors and the three-phase motor are simultaneously driven.

In addition, the step of driving the three-phase motor may be a step of driving the three-phase motor by controlling on/off of two series circuits among the first to fourth series circuits when the first and second EPB motors and the three-phase motor are simultaneously driven.

According to the present disclosure, instead of deleting an H-bridge circuit for driving the first and second EPB motors, a fourth series circuit is additionally provided in a three-phase inverter for driving a three-phase motor such that the three-phase motor as well as the first and second EPB motors can be driven together, and through this, it is possible to implement the miniaturization of an integrated brake device.

In addition, according to the present disclosure, compared to the previous method for controlling an integrated brake device which is configured with two H-bridge circuits (8 switches) for driving the first and second EPB motors and a three-phase inverter (6 switches) for driving a three-phase motor, the method for controlling an integrated brake device according to the present disclosure can reduce the cost of parts by reducing the number of parts, because it is configured with one H-bridge circuit (8 switches).

In addition, according to the present disclosure, even if any one of the first to fourth series circuits fails when a three-phase motor is driven, the three-phase motor can be driven by controlling on/off of the remaining series circuits, and through this, it is possible to prevent host vehicle accidents by ensuring redundancy.

In addition, according to the present disclosure, when the three-phase motor and the first and second EPB motors are simultaneously driven, they can be driven in a degrade mode, and through this, it is possible to prevent host vehicle accidents by securing minimum host vehicle stability.

Effects of the present disclosure are not limited to those mentioned above, and other effects that are not mentioned will be clearly understood by those skilled in the art from the description below.

### BRIEF DESCRIPTION OF THE DRAWINGS

FIG. 1 is a schematic circuit diagram of a conventional integrated brake device for a host vehicle.

FIG. 2 is a schematic circuit diagram of an integrated brake device for a host vehicle according to an exemplary embodiment of the present disclosure.

FIGS. 3a and 3b are diagrams illustrating current flow according to the operation of a three-phase motor driver according to an exemplary embodiment of the present disclosure.

FIGS. 4a and 4b are diagrams illustrating current flow according to the operation of an EPB driver according to an exemplary embodiment of the present disclosure.

FIG. 5 is a diagram for explaining the redundancy operation when driving a three-phase motor of the integrated brake device for a host vehicle according to an exemplary embodiment of the present disclosure.

FIG. 6 is a diagram for explaining the simultaneous operation of a three-phase motor and an EPB motor of the integrated brake device according to an exemplary embodiment of the present disclosure.

FIG. 7 is a flowchart of the method for controlling an integrated brake device for a host vehicle according to an exemplary embodiment of the present disclosure.

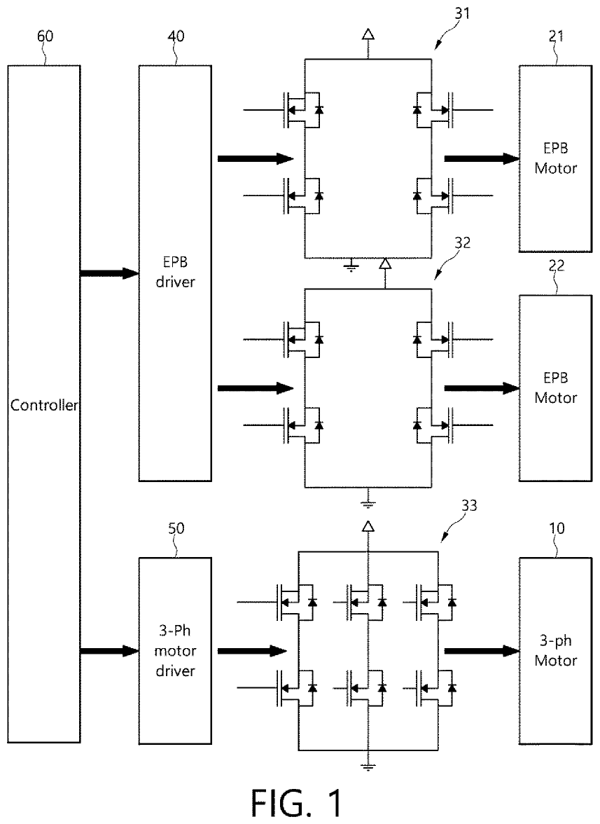

### DETAILED DESCRIPTION OF THE EMBODIMENTS

Hereinafter, with reference to the accompanying drawings, the exemplary embodiments of the present disclosure will be described in detail so that those skilled in the art can easily practice the present disclosure. The present disclosure may be embodied in many different forms and is not limited to the exemplary embodiments set forth herein. In order to clearly describe the present disclosure in the drawings, parts that are irrelevant to the description are omitted, and the same reference numerals are assigned to the same or similar components throughout the specification.

In the present specification, the term “include” or “have” is intended to designate that a feature, number, step, operation, component, part or combination thereof described in the specification exists, but it should be understood that it does not exclude in advance the possibility of the presence or addition of one or more other features, numbers, steps, operations, components, parts or combinations thereof.

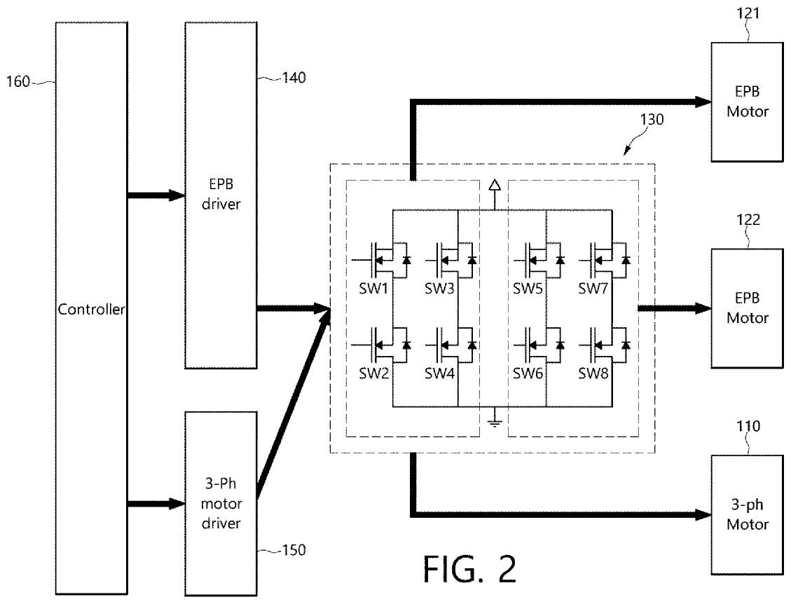

FIG. 2 is a schematic circuit diagram of an integrated brake device for a host vehicle according to an exemplary embodiment of the present disclosure.

Referring to FIG. 2, the integrated brake device (integrated dynamic brake; IDB) for a host vehicle according to an exemplary embodiment of the present disclosure may be configured by including a third-phase motor 110, a first EPB (electronic parking brake) motor 121, a second EPB motor 122, an H-bridge circuit 130, an EPB driver 140, an EPB driver 150 and a controller 160.

The three-phase motor 110 is a device that generates a braking force on the driving wheels of the host vehicle, and it generates a braking force on the driving wheels when the driver's will to brake is detected from the brake pedal.

Specifically, the integrated brake device detects when the driver presses on the brake pedal, opens or closes each valve to create a path through which the pressure is transmitted, and creates a high-pressure hydraulic pressure by using the three-phase motor 110 to transmit the same to each driving wheel, thereby a generating braking force.

The first EPB motor 121 and the second EPB motor 122 are devices that generate a parking braking force to the left and right rear wheels of the host vehicle during parking, and even if the driver does not manually operate the parking brake, when the host vehicle is stopped or when there is a concern that the host vehicle will be pushed back when starting on a hill, they automatically operate to maintain the parked or stopped state of the host vehicle.

The H-bridge circuit 130 includes a plurality of switches SW1 to SW8, and it may supply a current to at least one of the three-phase motor 110 and the first and second EPB motors 121, 122.

The plurality of switches SW1 to SW8 are power semiconductor switching elements, and may include an Insulated Gate Bipolar Transistor (IGBT), a Metal Oxide Semiconductor Field-Effect Transistor (MOS FET) or a transistor (Tr).

The plurality of switches SW1 to SW8 are turned on or off by PWM signals of the EPB driver 140 and the three-phase motor driver 150. When the plurality of switches SW1 to SW8 are IGBTs, the diodes are connected in parallel to the respective IGBTs such that current flows from the emitter side to the collector side of the IGBTs.

The EPB driver 140 may drive the first and second EPB motors 121, 122 by controlling the on/off of the plurality of switches SW1 to SW8.

The three-phase motor driver 150 may drive the three-phase motor 110 by controlling the on/off of the plurality of switches SW1 to SW8.

The three-phase motor 110 and the first and second FPB motors 121, 122 are characterized in that current is supplied by one H-bridge circuit 130, respectively.

The H-bridge circuit 130 may include a first series circuit in which a first switch SW1 connected to a power supply and a second switch SW2 connected to a ground are connected in series through a first node N1, a second series circuit in which a third switch SW3 connected to a power supply and a fourth switch SW4 connected to a ground are connected in series through a second node N2, a third series circuit in which a fifth switch SW5 connected to a power supply and a sixth switch SW6 connected to a ground are connected in series through a third node N3, and a fourth series circuit in which a seventh switch SW7 connected to a power supply and an eighth switch SW8 connected to a ground are connected in series through a fourth node N4.

The first EPB motor 121 may be connected to first and second nodes N1, N2, and the second EPB motor 122 may be connected to third and fourth nodes N3, N4.

In addition, the three-phase motor 110 may be connected to three nodes among the first to fourth nodes N1 to N4. For example, the three-phase motor 110 may be connected to the first to third nodes N1 to N3.

The EPB driver 140 may drive the first EPB motor 121 by controlling the on/off of the first and second series circuits, and may drive the second EPB motor 122 by controlling the on/off of the third and fourth series circuits.

In addition, the three-phase motor driver 150 may drive the three-phase motor 110 by controlling on-off of three series circuits among the first to fourth series circuits. For example, the three-phase motor driver 150 may drive the three-phase motor 110 by controlling on/off of the first to third series circuits.

The controller 160 may apply control signals to the EPB driver 140 and the three-phase motor driver 150.

Specifically, the controller 160 may operate the H-bridge circuit 130 to drive the three-phase motor 110 based on the driver's braking intention information that is detected through a pedal displacement sensor and a current detector.

In addition, the controller 160 may detect when the parking brake is operated, when the host vehicle is stopped, or when there is a possibility that the host vehicle may be pushed back when starting on a hill, so as to operate the H-bridge circuit 130 to drive the first and second EPB motors 121, 122.

The three-phase motor driver 150 may adjust the magnitude of current to the three-phase motor 110 through the H-bridge circuit 130. Specifically, the three-phase motor driver 150 receives a control signal from the controller 160 and controls the on-off duty ratio of the plurality of switch elements SW1 to SW8 to adjust the magnitude of current supplied to the three-phase motor 110.

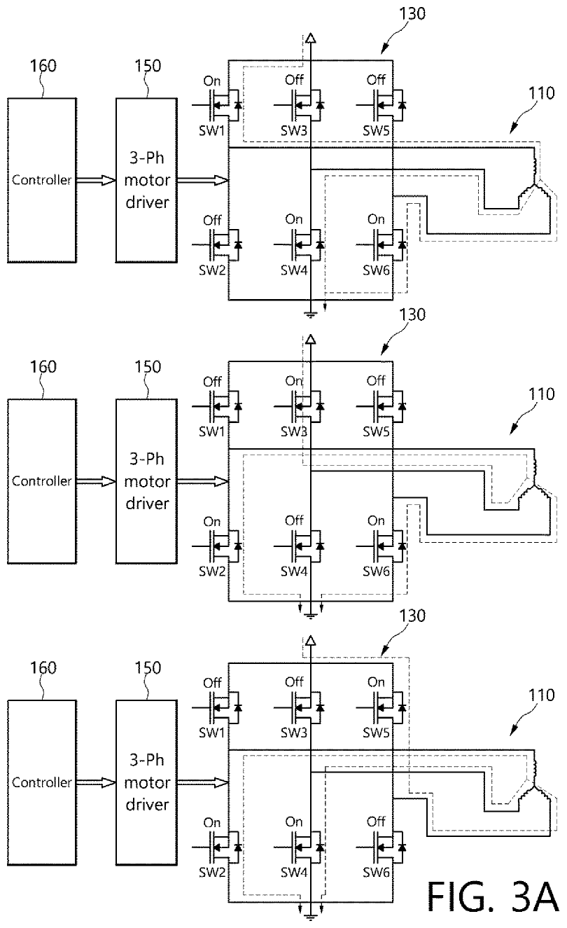

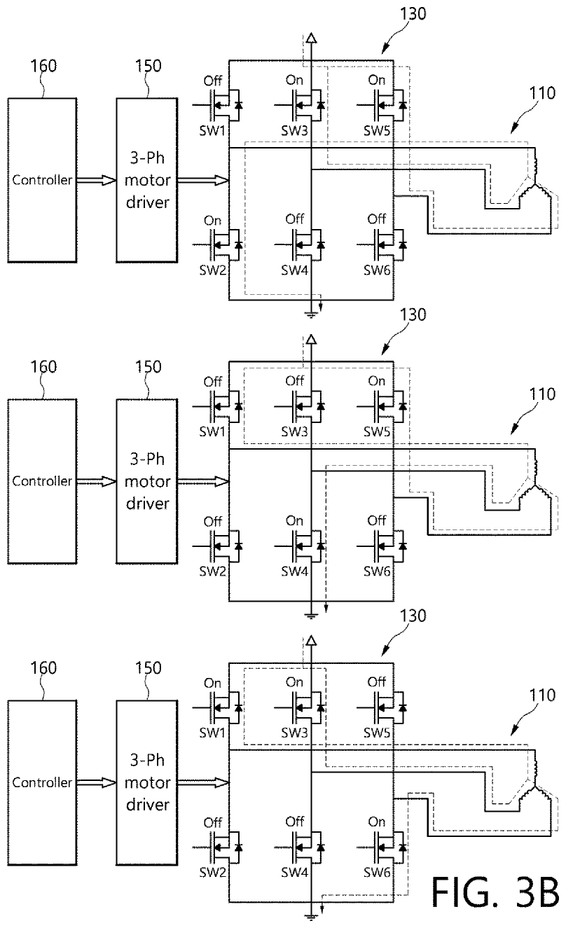

FIGS. 3a and 3b are diagrams illustrating current flow according to the operation of a three-phase motor driver according to an exemplary embodiment of the present disclosure.

Referring to FIGS. 3a and 3b, the three-phase motor driver 150 may operate only the first to third series circuits of the H-bridge circuit 130. Herein, the first to third series circuits perform the same function as a three-phase inverter for supplying three-phase alternating current to an existing three-phase motor.

The first switch SW1 and the second switch SW2 of the first series circuit operate opposite to each other, that is, when the first switch SW1 is turned on, the second switch SW2 is turned off, and when the first switch SW1 is turned off, the second switch SW2 is turned on.

In addition, the third switch SW3 and the fourth switch SW4 of the second series circuit operate opposite to each other, that is, when the third switch SW3 is turned on, the fourth switch SW4 is turned off, and when the third switch SW3 is turned off, the fourth switch SW4 is turned on.

In addition, the fifth switch SW5 and the sixth switch SW6 of the third series circuit operate opposite to each other, that is, when the fifth switch SW5 is turned on, the sixth switch SW6 is turned off, and when the fifth switch SW5 is turned off, the sixth switch SW6 is turned on.

In addition, the first switch SW1, the third switch SW3, and the fifth switch SW5 may operate as shown in Table 1 below.

TABLE 1

| | | | | | | |
|---|---|---|---|---|---|---|
| SW1 | Turn-On | Turn-Off | Turn-Off | Turn-Off | Turn-On | Turn-On |
| SW3 | Turn-Off | Turn-On | Turn-Off | Turn-On | Turn-Off | Turn-On |
| SW5 | Turn-Off | Turn-Off | Turn-On | Turn-On | Turn-On | Turn-Off |

When the three-phase motor driver 150 controls the first to third series circuits in the same manner as described above, three-phase AC current may be supplied to the three-phase motor 110.

Herein, the three-phase motor driver 150 may control the on/off duty ratio of the first to eighth switch elements SW1 to SW8 to adjust the magnitude of current supplied to the three-phase motor 110.

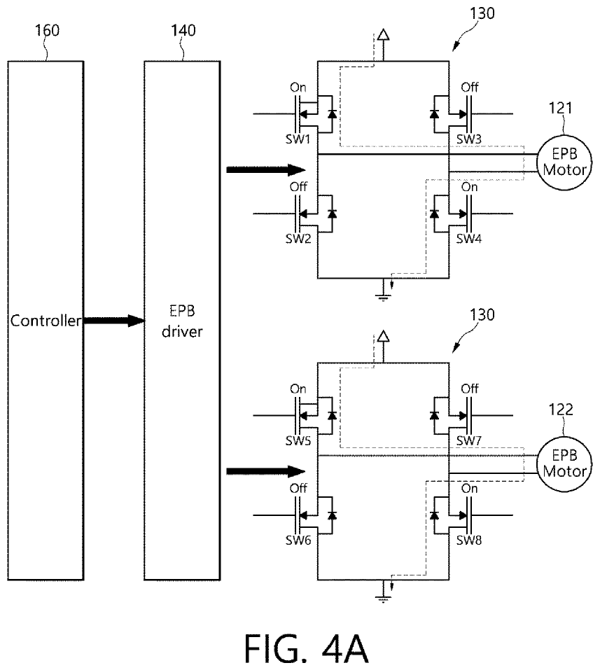

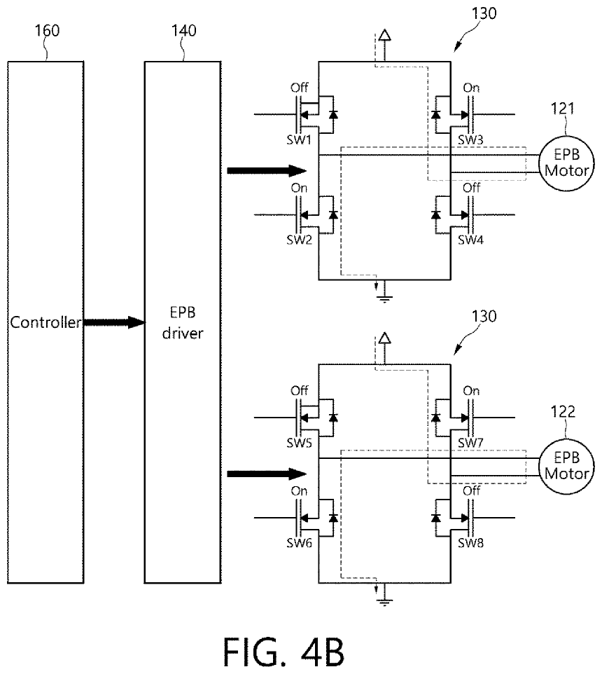

FIGS. 4a and 4b are diagrams illustrating current flow according to the operation of an EPB driver according to an exemplary embodiment of the present disclosure.

The EPB driver 140 may supply or cut off current to the first and second EPB motors 121, 122 through the H-bridge circuit 130.

Referring to FIGS. 4a and 4b, the EPB driver 140 may operate all of the first to fourth series circuits of the H-bridge circuit 130. Herein, the first EPB motor 121 may be operated by first and second series circuits, and the second EPB circuit 122 may be operated by third and fourth series circuits. That is, the first to fourth series circuits are obtained by adding a fourth series circuit to a three-phase inverter for supplying three-phase alternating current to an existing three-phase motor, and it performs the same function as two H-bridge circuits for respectively supplying direct current to the existing first and second EPB motors.

The first switch SW1 and the second switch SW2 of the first series circuit operate opposite to each other, that is, when the first switch SW1 is turned on, the second switch SW2 is turned off, and when the first switch SW1 is turned off, the second switch SW2 is turned on.

In addition, the third switch SW3 and the fourth switch SW4 of the second series circuit operate opposite to each other, that is, when the third switch SW3 is turned on, the fourth switch SW4 is turned off, and when the third switch SW3 is turned off, the fourth switch SW4 is turned on.

Referring to FIG. 4a, when the first switch SW1 is turned on and the third switch SW3 is turned off, a current path is created along the first switch SW1, the first FPB motor 121 and the fourth switch SW4 such that direct current in the forward direction is supplied to the first FPB motor 121. In addition, when the fifth switch SW5 is turned on and the seventh switch SW7 is turned off, a current path is created along the fifth switch SW5, the second FPB motor 122 and the seventh switch SW7 such that direct current in the forward direction is supplied to the second FPB motor 122.

Accordingly, the first and second FPB motors 121, 122 are rotated in the forward direction to generate a braking force on the rear wheels.

In contrast, referring to FIG. 4b, when the first switch SW1 is turned off and the third switch SW3 is turned on, a current path is created along the third switch SW3, the first FPB motor 121 and the second switch SW2 such that direct current in the reverse direction is supplied to the first FPB motor 121. In addition, when the fifth switch SW5 is turned off and the seventh switch SW7 is turned on, a current path is created along the seventh switch SW7, the second FPB motor 122 and the sixth switch SW6 such that direct current in the reverse direction is supplied to the second FPB motor 122.

Accordingly, the first and second FPB motors 121, 122 are rotated in opposite directions to release the braking force applied to the rear wheels.

As described above, the integrated brake device for a host vehicle according to an exemplary embodiment of the present disclosure may drive not only the three-phase motor but also the first and second EPB motors together by additionally including a fourth series circuit in the three-phase inverter for driving the three-phase motor instead of deleting the H-bridge circuit for driving the first and second EPB motors, and through this, it is possible to implement the miniaturization of the integrated brake device.

In addition, compared to the existing integrated brake device which is composed of two H-bridge circuits (8 switches) for driving the first and second EPB motors and a three-phase inverter (6 switches) for driving the three-phase motor, the integrated brake device of the present disclosure is composed of one H-bridge circuit (8 switches), and thus, the number of parts may be reduced to reduce component costs.

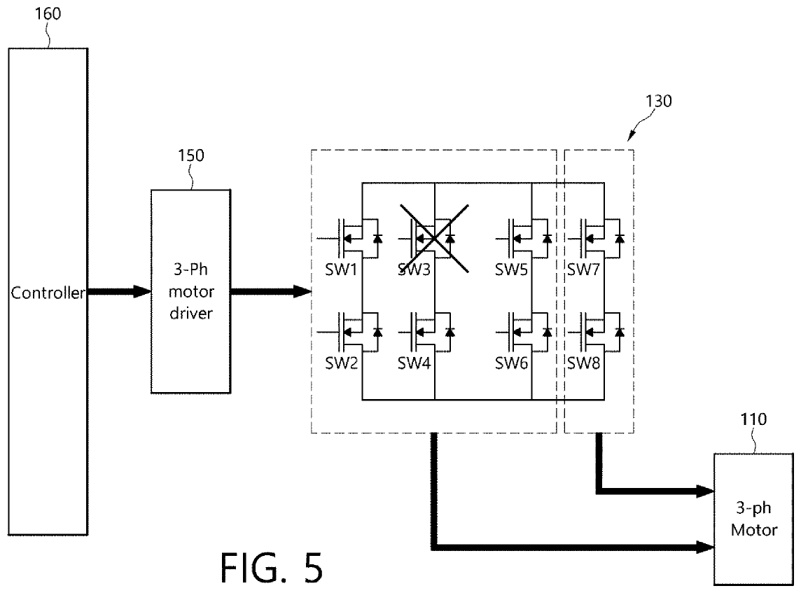

FIG. 5 is a diagram for explaining the redundancy operation when driving a three-phase motor of the integrated brake device for a host vehicle according to an exemplary embodiment of the present disclosure.

The three-phase motor driver 150 may drive the three-phase motor by controlling the on/off of the remaining series circuits when any one of the first to fourth series circuits of the H-bridge circuit 130 fails.

For example, referring to FIG. 5, when the three-phase motor 110 is driven by using the first to third series circuits of the H-bridge circuit 130, if the second series circuit is not operated because the third switch SW3 of the second series circuit is damaged, the three-phase AC current may be supplied to the three-phase motor 110 by using the fourth series circuit that has not been used to drive the three-phase motor 110.

Herein, the failure determination of the series circuit and the replacement with a normal series circuit upon the failure determination may be performed through a separate redundancy driver (not illustrated).

As described above, when the three-phase motor 110 is driven, the integrated brake device for a host vehicle according to an exemplary embodiment of the present disclosure may control the on/off of the remaining series circuits even if any one of the first to fourth series circuits fails, so as to drive the three-phase motor 110, and through this, it is possible to prevent accidents of the host vehicle by securing redundancy.

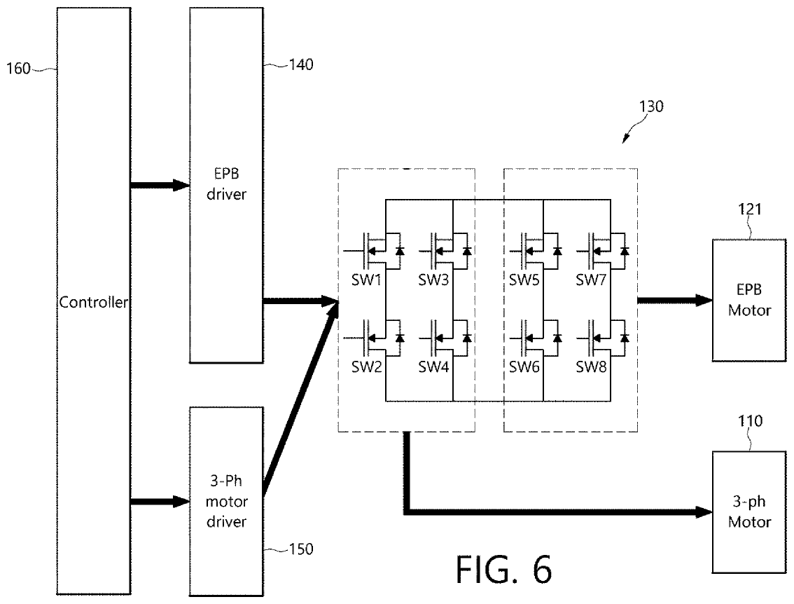

FIG. 6 is a diagram for explaining the simultaneous operation of a three-phase motor and an EPB motor of the integrated brake device according to an exemplary embodiment of the present disclosure.

Depending on driving conditions, there are cases in which the three-phase motor and the EPB motor are simultaneously operated. In this case, the present disclosure may perform a degrade mode operation.

Referring to FIG. 6, when the first and second EPB motors 121, 122 and the three-phase motor 110 are simultaneously driven, the EPB driver 140 may drive only one of the first and second EPB motors 121, 122.

In addition, when the first and second EPB motors 121, 122 and the three-phase motor 110 are simultaneously driven, the three-phase motor driver 150 may control the on-off of two series circuits among the first to fourth series circuits, so as to drive the three-phase motor 110 in two phases.

As described above, when the three-phase motor 110 and the first and second EPB motors 121, 122 are simultaneously driven, the integrated brake device for a host vehicle according to an exemplary embodiment of the present disclosure may be driven in a degrade mode, and through this, it is possible to prevent host vehicle accidents by securing the minimum stability of the host vehicle.

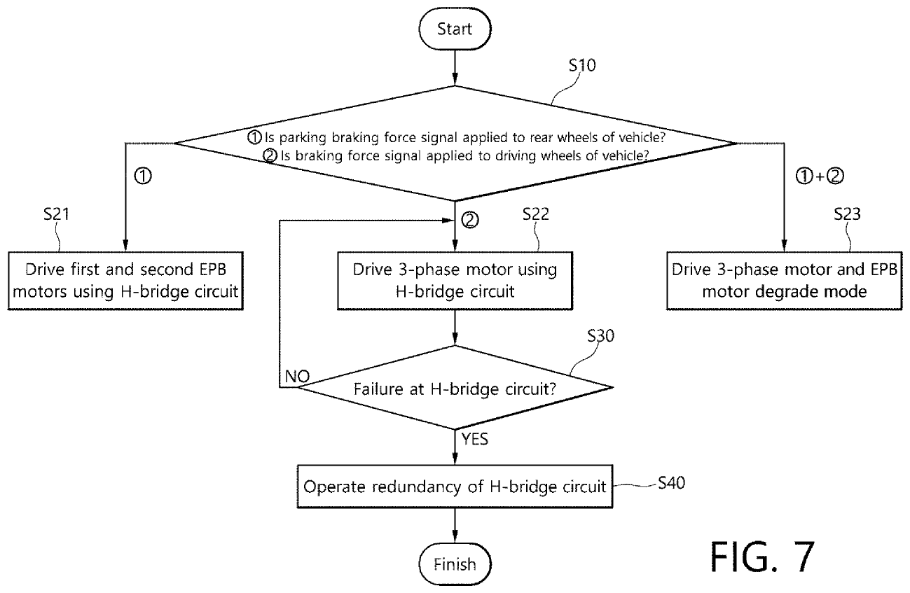

FIG. 7 is a flowchart of the method for controlling an integrated brake device for a host vehicle according to an exemplary embodiment of the present disclosure.

Hereinafter, the method for controlling an integrated brake device for a host vehicle according to an exemplary embodiment of the present disclosure will be described, but the same contents as the above-described integrated brake device for a host vehicle according to an exemplary embodiment of the present disclosure will be omitted.

The present disclosure is a method for controlling an integrated brake device for a host vehicle, including first to fourth series circuits in which two switches are connected in series between a power supply and a ground, and an H-bridge circuit 130 for supplying a current to at least one of the three-phase motor 110 and the first and second EPB motors 121, 122.

Referring to FIG. 7, first of all, the controller 150 determines whether a parking braking force signal is applied to the rear wheels of the host vehicle or/and whether a braking force signal is applied to the driving wheels of the host vehicle (S10).

Herein, when a parking braking force is generated on the rear wheels of the host vehicle, the first and second series circuits of the H-bridge circuit 130 are controlled to drive the first EPB motor 121, and the third and fourth series circuits are controlled to drive the second EPB motor 122 (S21).

Unlike the above, when a braking force is generated in the driving wheels of the host vehicle, the three-phase motor 110 is driven by controlling the on-off of three series circuits among the first to fourth series circuits of the H-bridge circuit 130 (S22).

In contrast, when a parking braking force is generated on the rear wheels of the host vehicle and a braking force is generated on the driving wheels of the host vehicle at the same time, the vehicle operates in the degrade mode (S23).

Specifically, when the first and second EPB motors 121, 122 and the three-phase motor 110 are simultaneously driven, only one of the first and second EPB motors 121, 122 is driven, and the three-phase motor 110 is driven in two phases by controlling the on-off of two series circuits among the first to fourth series circuits of the H-bridge circuit 130.

Next, when the three-phase motor 110 is driven, it is determined whether the first to fourth series circuits of the H-bridge circuit 130 have failed (S30).

Herein, when any one of the first to fourth series circuits of the H-bridge circuit 130 fails, the three-phase motor 110 is driven by controlling the on-off of the remaining series circuits (S40).

As described above, in the method for controlling an integrated brake device for a host vehicle according to an exemplary embodiment of the present disclosure, instead of deleting the H-bridge circuit for driving the first and second EPB motors, the three-phase inverter for driving the three-phase motor is additionally provided with a fourth series circuit such that not only the three-phase motor but also the first and second EPB motors may be driven together, and through this, it is possible to implement the miniaturization of the integrated brake device.

In addition, compared to the conventional control method of the integrated brake device which is composed of of two H-bridge circuits (8 switches) for driving the first and second EPB motors and a three-phase inverter (6 switches) for driving the three-phase motor, the method for controlling an integrated brake device according to the present disclosure may reduce the number of parts to reduce component costs, because it is composed of one H-bridge circuit (8 switches).

Further, in the method for controlling an integrated brake device of a host vehicle according to an exemplary embodiment of the present disclosure, even if any one of the first to fourth series circuits fails when the three-phase motor 110 is driven, the three-phase motor 110 may be driven by controlling the on-off of the remaining series circuits, and through this, it is possible to prevent accidents of the host vehicle by securing redundancy.

Further, in the method for controlling an integrated brake device of a host vehicle according to an exemplary embodiment of the present disclosure, when the three-phase motor 110 and the first and second EPB motors 121, 122 are simultaneously driven, they may be driven in a degrade mode, and through this, it is possible to prevent host vehicle accidents by securing minimum stability of the host vehicle.

Although an exemplary embodiment of the present disclosure has been described above, the spirit of the present disclosure is not limited to the exemplary embodiments presented herein, and those skilled in the art who understand the spirit of the present disclosure may easily suggest other exemplary embodiments by modifying, changing, deleting or adding components within the scope of the same spirit, but this will also fall within the spirit of the present disclosure.

What is claimed is:

1. A brake device for a host vehicle, comprising:
a three-phase motor for generating a braking force to driving wheels of the host vehicle;
first and second EPB motors for generating a parking braking force to rear wheels of the host vehicle;
an H-bridge circuit comprising a plurality of switches and supplying a current to at least one of the three-phase motor and the first and second EPB motors;
an EPB driver for controlling on/off of the plurality of switches to drive the first and second EPB motors; and
a three-phase motor driver for controlling on/off of the plurality of switches to drive the three-phase motor.

2. The brake device of claim 1, wherein the three-phase motor and the first and second FPB motors are respectively supplied with a current by one H-bridge circuit.

3. The brake device of claim 1, wherein the H-bridge circuit comprises:
a first series circuit in which a first switch connected to a power supply and a second switch connected to a ground are connected in series through a first node; and
a second series circuit in which a third switch connected to a power supply and a fourth switch connected to a ground are connected in series through a second node

4. The brake device of claim 3, wherein the H-bridge circuit comprises:
a third series circuit in which a fifth switch connected to a power supply and a sixth switch connected to a ground are connected in series through a third node; and
a fourth series circuit in which a seventh switch connected to a power supply and an eighth switch connected to a ground are connected in series through a fourth node.

5. The brake device of claim 4, wherein the EPB driver controls on/off of the first and second series circuits to drive the first EPB motor, and controls on/off of the third and fourth series circuits to drive the second EPB motor.

6. The brake device of claim 4, wherein the three-phase motor driver controls on/off of three series circuits among the first to fourth series circuits to drive the three-phase motor.

7. The brake device of claim 6, wherein when any one of the first to fourth series circuits fails, the three-phase motor driver controls on/off of the remaining series circuits to drive the three-phase motor.

8. The brake device of claim 4, wherein the first EPB motor is connected to the first and second nodes, and
wherein the second EPB motor is connected to the third and fourth nodes.

9. The brake device of claim 4, wherein the three-phase motor is connected to three nodes among the first to fourth nodes.

10. The brake device of claim 4, wherein when the first and second EPB motors and the three-phase motor are simultaneously driven, the EPB driver drives only one of the first and second EPB motors.

11. The brake device of claim 4, wherein when the first and second EPB motors and the three-phase motor are simultaneously driven, the three-phase motor driver controls on/off of two series circuits among the first to fourth series circuits to drive the three-phase motor.

12. The brake device of claim 1, further comprising:
a controller for applying control signals to the EPB driver and the three-phase motor driver.

13. The brake device of claim 1, wherein the EPB driver supplies a current to the first and second EPB motors in the forward or reverse direction through the H-bridge circuit.

14. The brake device of claim 1, wherein the three-phase motor driver controls the magnitude of a current that is supplied to the three-phase motor through the H-bridge circuit.

15. The brake device of claim 14, wherein the three-phase motor driver controls the on-off duty ratio of the plurality of switch elements to adjust the magnitude of a current that is supplied to the three-phase motor.

16. A method for controlling a brake device for a host vehicle, which is a method for controlling a brake device for a host vehicle comprising first to fourth series circuits in which two switches are connected in series between a power supply and a ground, and an H-bridge circuit for supplying a current to at least one of a three-phase motor and first and second EPB motors, the method comprising the steps of:
driving the first EPB motor by controlling the first and second series circuits and driving the second EPB motor by controlling the third and fourth series circuits when a parking braking force is generated in rear wheels of the host vehicle; and
driving the three-phase motor by controlling on/off of three series circuits among the first to fourth series circuits when a braking force is generated in driving wheels of the host vehicle.

17. The method of claim 16, wherein the step of driving the three-phase motor is a step of driving the three-phase motor by controlling on/off of the remaining series circuits when any one of the first to fourth series circuits fails.

18. The method of claim 16, wherein the step of driving the first and second EPB motors is a step of driving only one of the first and second EPB motors when the first and second EPB motors and the three-phase motor are simultaneously driven.

19. The method of claim 18, wherein the step of driving the three-phase motor is a step of driving the three-phase motor by controlling on/off of two series circuits among the first to fourth series circuits when the first and second EPB motors and the three-phase motor are simultaneously driven.
